(19) United States
(12) Patent Application Publication
(10) Pub. No.: US 2018/0136832 A1
(43) Pub. Date: May 17, 2018

(54) CIRCULAR USER INTERFACE

(71) Applicant: KONINKLIJKE PHILIPS N.V., EINDHOVEN (NL)

(72) Inventors: REMCO TIMMER, UTRECHT (NL); JELTE BIJKERK, AMSTERDAM (NL)

(21) Appl. No.: 15/212,687

(22) PCT Filed: Jun. 28, 2016
(86) PCT No.: PCT/IB2016/053838

§ 371 Date: Jul. 18, 2016

Related U.S. Application Data
(60) Provisional application No. 62/193,149, filed on Jul. 16, 2015.

(51) Int. Cl. G06F 3/0488; G06F 9/451; G06F 3/0482; G06F 3/0484

(52) U.S. Cl. CPC G06F 3/04883; G06F 9/451; G06F 3/04817; G06F 3/04847; G06F 3/0482

(57) ABSTRACT

A circular user interface (UI) that permits a user to select options and input subjective data (e.g., values and arrays) with a circular gesture-based interaction style in an easy, efficient and fast way. The UI is useful on circular devices that provide a display of, e.g., health and behavior measurements; it uses the circular shape of the device to guide the user and shows guiding animating elements on the display.

### CROSS-REFERENCE TO RELATED APPLICATIONS

This patent application claims the priority benefit under 35 U.S.C. § 119(e) of U.S. Provisional Application No. 62/193,149, filed on Jul. 16, 2015, the contents of which are herein incorporated by reference.

### FIELD OF THE INVENTION

The present invention generally relates to a user interface designed for easy interaction, and more specifically to a circular user interface suited to a variety of applications.

### BACKGROUND OF THE INVENTION

Electronic devices have become increasingly portable with the passage of time. Digital computers began as room-sized appliances that were installed in a particular location. Moore's law and the progressive miniaturization and integration of components first made digital computers portable, and now wearable.

As these devices have evolved, so have their interfaces for receiving commands and data and displaying information. The earliest computers utilized switches and punch card readers for input, and lights for feedback. Portable, movable computers use a variety of interface items: keyboards, tablets, speech recognition, etc.

Wearable computers call for a new paradigm for user interaction. Wearables are typically too large to accommodate an effective keyboard interface. Current wearables typically utilize a touch screen, buttons, or both. Wearables with circular displays typically utilize known interaction techniques such as swipes and multi-touch inputs. However, these interaction techniques can be slow and cumbersome.

Accordingly, there is a need for methods and systems that allow for facile and quick interaction with computing devices, particular computing devices that are wearable.

### SUMMARY OF THE INVENTION

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments of the present invention provide a circular user interface (UI) that permits a user to select options and input subjective data (e.g., values and arrays) with a circular gesture-based interaction style in an easy, efficient and fast way. The UI is useful on circular devices that provide a display of, e.g., health and behavior measurements; it uses the circular shape of the device to guide the user and shows guiding animating elements on the display.

In one aspect, embodiments of the present invention relate to a computer-implemented method for providing an interactive user interface. The method includes providing a computer processor configured to: provide a graphical display on the interactive user interface divided into a central region and a peripheral region; receive an input from the user on the peripheral region of the interactive user interface, the input being a clockwise or counterclockwise motion in the peripheral region; and recognize a selection by the user when the user discontinues the input without requiring an additional input by the user.

In one embodiment, the graphical display comprises an icon. In one embodiment, the graphical display includes an indicator that coincides with the location of the input received from the user on the peripheral region. In one embodiment, the clockwise motion in the peripheral region increments a numerical value. In one embodiment, the counterclockwise motion in the peripheral region decrements a numerical value.

In one embodiment, the input received from the user traverses a list of menu items, and the discontinuation of the input constitutes the selection of the presently-displayed menu item. In one embodiment, the input received from the user traverses a list of displayed items. In one embodiment, the computer processor is further configured to display a graphical item that lets the user confirm or reject the selection. In one embodiment, the interactive user interface is circular. In one embodiment, the computer processor is further configured to display on the interactive user interface a transition between two numerical values.

In another aspect, embodiments of the present invention relate to a computer readable medium containing computer-executable instructions for performing a method for providing an interactive user interface. The medium includes computer-executable instructions for providing a graphical display on the interactive user interface divided into a central region and a peripheral region; computer-executable instructions for receiving an input from a user on the peripheral region of the interactive user interface, the input being a clockwise or counterclockwise motion in the peripheral region; and computer-executable instructions for recognizing a selection by the user when the user discontinues the input without requiring an additional input by the user.

In one embodiment, the provided graphical display comprises an icon. In one embodiment, the provided graphical display comprises an indicator that coincides with the location of the input received from the user on the peripheral region. In one embodiment, the computer-executable instructions interpret the clockwise motion in the peripheral region to increment a numerical value. In one embodiment, the computer-executable instructions interpret the counterclockwise motion in the peripheral region to decrement a numerical value.

In one embodiment, the computer-executable instructions interpret the input received from the user as the traversal of a list of menu items, and the discontinuation of the input constitutes the selection of the presently-displayed menu item. In one embodiment, the computer-executable instructions interpret the input received from the user as the traversal of a list of displayed items. In one embodiment, the computer readable medium further comprises computer-executable instructions for displaying a graphical item that lets the user confirm or reject the selection. In one embodiment, the interactive user interface is circular. In one embodiment, the computer readable medium further comprises computer-executable instructions for displaying on the interactive user interface a transition between two numerical values.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 depicts an example of one embodiment of a method for providing a circular user interface in accord with the present invention;

FIG. 2 is a schematic representation of an embodiment of an apparatus for providing a circular user interface according to the present invention; and

FIG. 3 describes an interaction between a user and a circular user interface provided by an embodiment of the present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the present invention relate to a circular user interface that permits a user to easily and efficiently select options and input data. Such an interface is naturally suited to circular devices, such as smartwatches with circular faces, although the interface may also be used in traditional computing environments and applications, including but not limited to web interfaces.

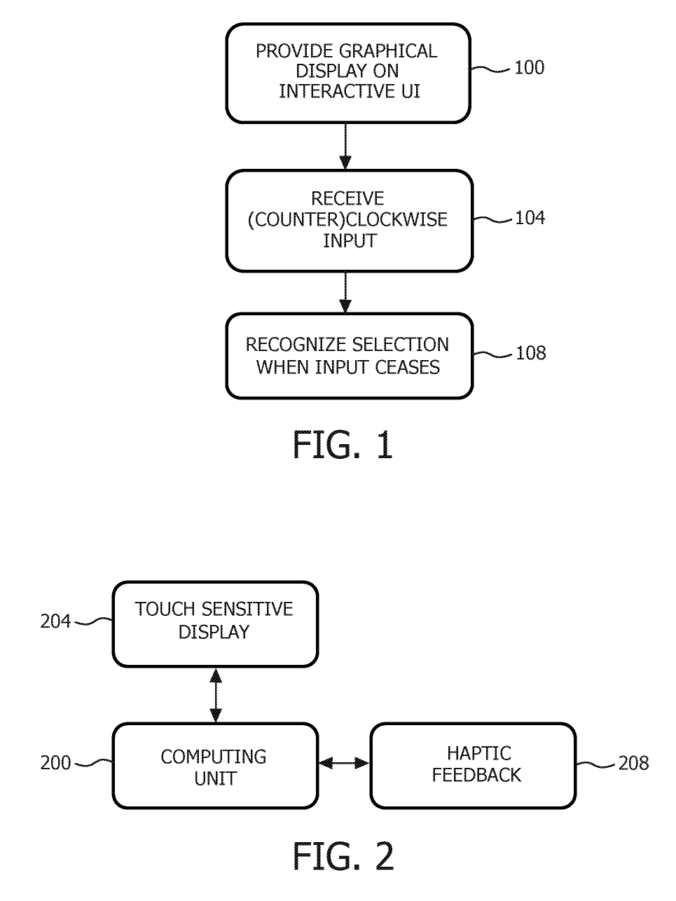

FIG. 1 is a flowchart of an exemplary method for providing a circular user interface in accord with the present invention. In this example, the process begins when a computer processor provides a graphical display on an interactive user interface divided into a central region and a peripheral region (Step 100). The computer processor receives an input from the user on the peripheral region of the interactive user interface, the input being a clockwise or counterclockwise motion in the peripheral region (Step 104). The computer processor recognizes a selection by the user when the user discontinues an input by, e.g., lifting their finger away from the interactive surface, without requiring an addition input from the user (Step 108).

The graphical display will typically have an icon or other indicator in the central region of the interactive display as the user interacts with the peripheral region. An indicator may be displayed once the user makes contact with the peripheral region, and the indicator may, e.g., follow the position of the user's finger as it traces the peripheral region in a clockwise or counterclockwise direction.

The contents of the central region may vary as the user interacts with the peripheral region, and the contents may vary in accord with the type of display in the central region. For example, when a number is displayed in the central region, then the user's interaction with the peripheral region may increment or decrement the number displayed in the central region. If the content is displayed in the central region is, e.g., a list, then the user's input may traverse a list of items and the discontinuation of the input results in the selection of a particular list item. In some embodiments, the user may be prompted to confirm or reject a particular selection or entry.

It would be apparent to one of ordinary skill that the order of steps in the preceding discussion is not necessarily canonical. For example, one of ordinary skill would recognize that the steps of the method can be repeated arbitrarily as part of a seriatim or more complicated input sequence.

FIG. 2 is a block diagram of an exemplary system for presenting a circular user interface in accord with the present invention. In this embodiment, a computing unit 200 is in communication with a touch-sensitive display 204 and a source of haptic feedback 208.

The computing unit 200 may take a variety of forms in various embodiments. Exemplary computing units suitable for use with the present invention typically include one or more commercially-available microprocessors, such as an x86-architecture microprocessor. The touch-sensitive display 204 may include an LCD or LED display with a capacitive or resistive touch sensor overlay. The haptic feedback source 208 may be, e.g., a motor having an off-center load.

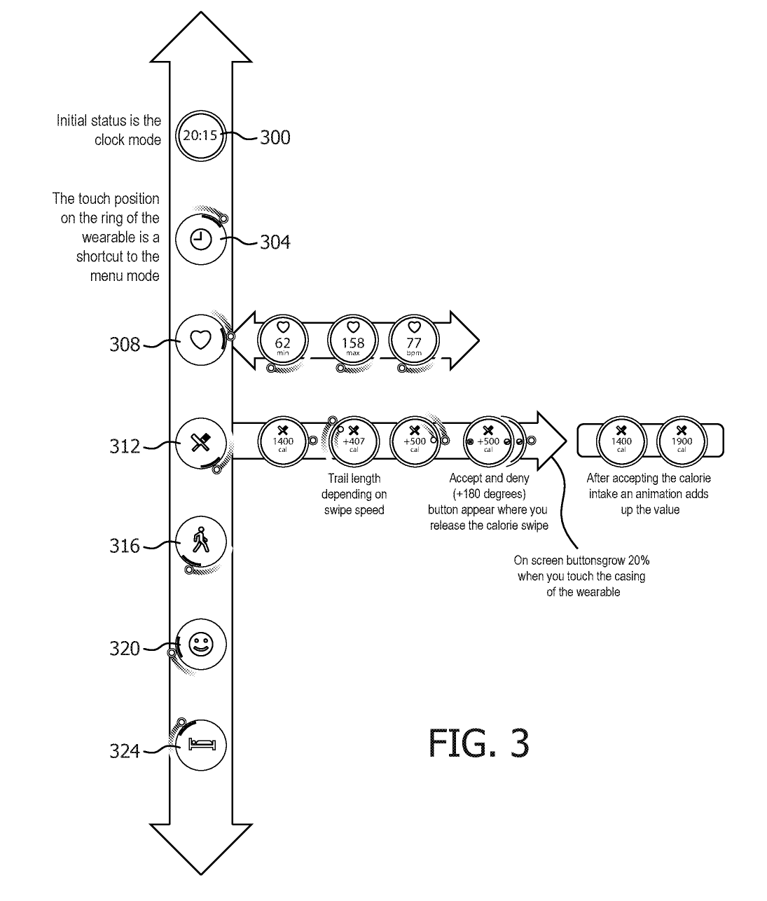

FIG. 3 describes how a user might interact with a circular user interface in accord with the present invention. In this example, the user is interacting with a circular user interface displayed on a wearable computer with a wristwatch form factor.

The example begins with the wearable in its default state, displaying the current time 300. The time may be, e.g., in military format or standard time format (AM/PM).

The user begins interacting with the wearable by touching the peripheral region of the interactive user interface 304. The wearable may respond to the touch by transitioning into a menu mode, i.e., presenting the user with a sequential set of icons that the user may interact with and select to change the wearable's current function. For example, in the illustrated example entering menu mode changes the displayed time into an icon that is representative of the wearable's current operation, i.e., a watch. The wearable may also respond to the touch by displaying an indicator on the peripheral region where the user is touching it.

As depicted in the two-headed grey arrow, the user may trace their finger in a clockwise or counterclockwise direction around the periphery of the display and thereby step through a set of icons representative of the functions offered by the wearable: a heart, dining utensils, a walking man, a smiley face, etc.

Haptic feedback may be used at any point in the process of interaction to, e.g., indicate that an option has been selected, that a touch has been received, etc. Some embodiments may also utilize haptic feedback to alleviate the need for the user to check the display for feedback or confirmation.

The heart icon 308 indicates that the user will put the wearable into cardiometer mode. If the user selects cardiometer mode, i.e., by removing their finger from the display, the wearable will respond by displaying the user's current heart rate. If the user subsequently touches the display, the wearable will respond by displaying additional heart rate information, here the minimum heart rate for the monitoring period and the maximum heart rate for the monitoring period. The subsequent interaction may take the form of, e.g., the user touching the perimeter of the display and tracing the perimeter in a clockwise or counter-clockwise direction, i.e., using the same motion used to initially select the menu item.

The crossed dining utensils 312 indicate that the user will put the wearable into calorie counting mode by removing their finger from the display. If the user selects the calorie counting mode, then the wearable will respond by displaying the current calorie count. The user can record an increase in the number of calories consumed by touching the user interface near the perimeter and tracing the perimeter in a clockwise direction. In one embodiment, the interface only begins the increment operation if the user touches the user interface in a particular spot, here indicated by a black plus sign in a white circle. In one embodiment, the calorie count may increment faster if the user moves their finger faster; in another embodiment, the rate of increment may stay constant despite the rate of the user's motion.

Once the user's finger is removed, the increment operation ceases. In some embodiments, the user may be asked to confirm the value entered by, e.g., presenting an “approve” icon (such as a check mark) or a “reject” icon (such as an “x”). The user may confirm the entered value by selecting the “approve” icon and reject the entered value by selecting the “reject” icon. The icons may also be appropriately colored (e.g., green to approve; red to reject) and positioned (e.g., at opposite ends of the user interface, perhaps in alignment with the last location of the user's finger, etc.). In one embodiment, swiping the screen instead of selecting “approve” or “reject” will result in the resumption of the incrementing process described above.

Of course, the user may interact with the calorie counting mode by decrementing the calorie count. The decrementing operation is generally analogous to the incrementing operation discussed above, although it typically requires the user to, e.g., drag their finger in an anti-clockwise direction when the incrementing operation requires clockwise motion (or vice versa).

In some embodiments, the addition of the entered value to the current calorie count may be animated, i.e., showing a scrolling count from the current value to the final value. In other embodiments, the final value may simply be displayed without any interim animation.

The walking man icon 316 indicates that the user will put the wearable into pedometer mode. If the user selects pedometer mode, i.e., by removing their finger from the display, then the wearable will respond by displaying the user's current step count. If the user subsequently touches the display, the wearable may respond by, e.g., resetting the step count or displaying a step count for a certain discrete time period.

The happy face icon 320 indicates that the user will put the wearable into emotion journaling mode. If the user selects emotion journaling mode, i.e., by removing their finger from the display, then the wearable will respond by providing the user without another menu of icons representing individual moods (e.g., happy, sleepy, bored, angry, etc.) that the user may traverse in a manner analogous to the presently described process for selecting among menu choices 300-24. When the user subsequently selects an icon representing his or her current emotional state, then the wearable will make a record of the selected emotional state along with, e.g., the time and date of the selection.

The sleeping man icon 324 indicates that the user will put the wearable into sleep monitor mode. If the user selects sleep monitor mode, i.e., by removing their finger from the display, then the wearable will respond by closely monitoring the user's movement and assuming that the monitored period corresponds to the user's sleep cycle. The stored movement data may be later reviewed and evaluated to give the user feedback concerning the quality of their sleep.

It would be apparent to one of ordinary skill that although the foregoing discussion specifically concerns a wearable personal health device, it also presents methods that are suitable for a variety of interactions in a variety of contexts utilizing a variety of devices. For example, the method for selecting a menu option 300-24 is generally applicable to the selection of any particular option from a plurality of options, whether that plurality be presented on a wearable device, a traditional computer display, etc. Similarly, the method for entering a numerical value in connection with calorie counting mode 312, including the confirmation dialog and/or the animations, may be applied to the entry of any numerical value. Likewise, the method for traversing a plurality of displays associated with a particular menu option as in, e.g., connection with cardiometer 308, may be generalized to the traversal of any plurality of displays associated with a particular menu option.

It would also be apparent to one of ordinary skill that embodiments of the foregoing invention offer several advantages relative to prior art user interfaces. For example, placing the touch sensitive area of the user interface around the perimeter of the interface mitigates the possibility that the user will obstruct the display while interacting with the interface. The entry of data is intuitive given the round form factor, and can be performed quickly without requiring the learning of a specialized interface or multiple touches.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A computer-implemented method for providing an interactive user interface, the method comprising:
providing a computer processor configured to:
(a) provide a graphical display on the interactive user interface divided into a central region and a peripheral region;
(b) receive an input from the user on the peripheral region of the interactive user interface, the input being a clockwise or counterclockwise motion in the peripheral region; and
(c) recognize a selection by the user when the user discontinues the input without requiring an additional input by the user.

2. The computer-implemented method of claim 1 wherein the graphical display comprises an icon.

3. The computer-implemented method of claim 1 wherein the graphical display comprises an indicator that coincides with the location of the input received from the user on the peripheral region.

4. The computer-implemented method of claim 1 wherein the clockwise motion in the peripheral region increments a numerical value.

5. The computer-implemented method of claim 1 wherein the counterclockwise motion in the peripheral region decrements a numerical value.

6. The computer-implemented method of claim 1 wherein the input received from the user traverses a list of menu items, and the discontinuation of the input constitutes the selection of the presently-displayed menu item.

7. The computer-implemented method of claim 1 wherein the input received from the user traverses a list of displayed items.

8. The computer-implemented method of claim 1 wherein the computer processor is further configured to display a graphical item that lets the user confirm or reject the selection.

9. The computer-implemented method of claim 1 wherein the interactive user interface is circular.

10. The computer-implemented method of claim 1 wherein the computer processor is further configured to display on the interactive user interface a transition between two numerical values.

11. A computer readable medium containing computer-executable instructions for performing a method for providing an interactive user interface, the medium comprising:
(a) computer-executable instructions for providing a graphical display on the interactive user interface divided into a central region and a peripheral region;
(b) computer-executable instructions for receiving an input from a user on the peripheral region of the interactive user interface, the input being a clockwise or counterclockwise motion in the peripheral region; and
(c) computer-executable instructions for recognizing a selection by the user when the user discontinues the input without requiring an additional input by the user.

12. The computer readable medium of claim 11 wherein the provided graphical display comprises an icon.

13. The computer readable medium of claim 11 wherein the provided graphical display comprises an indicator that coincides with the location of the input received from the user on the peripheral region.

14. The computer readable medium of claim 11 wherein the computer-executable instructions interpret the clockwise motion in the peripheral region to increment a numerical value.

15. The computer readable medium of claim 11 wherein the computer-executable instructions interpret the counterclockwise motion in the peripheral region to decrement a numerical value.

16. The computer readable medium of claim 11 wherein the computer-executable instructions interpret the input received from the user as the traversal of a list of menu items, and the discontinuation of the input constitutes the selection of the presently-displayed menu item.

17. The computer readable medium of claim 11 wherein the computer-executable instructions interpret the input received from the user as the traversal of a list of displayed items.

18. The computer readable medium of claim 11 further comprising computer-executable instructions for displaying a graphical item that lets the user confirm or reject the selection.

19. The computer readable medium of claim 11 wherein the interactive user interface is circular.

20. The computer readable medium of claim 11 further comprising computer-executable instructions for displaying on the interactive user interface a transition between two numerical values.
